(19) United States
(12) Patent Application Publication
(10) Pub. No.: US 2009/0012636 A1
(43) Pub. Date: Jan. 8, 2009

(54) METHOD FOR RECORDING A PRESENTATION

(76) Inventors: Rong-Hua KUNG, Hsichih (TW); Jin-Yuan Wang, Hsichih (TW)

Correspondence Address: HDSL, P.O. BOX 220746, CHANTILLY, VA, 20153-0746, US

(21) Appl. No.: 12/127,117

(22) Filed: May 27, 2008

(30) Foreign Application Priority Data
Jul. 3, 2007 (TW) 096124081

(51) Int. Cl. G10L 11/00; G06F 17/00

(52) U.S. Cl. 700/94; 704/270

(57) ABSTRACT

A method for recording a speaker's voice and operations during a computer aided presentation is disclosed. The method records the speaker's voice to convert into a voice data packet (VDP) when a presentation file, such as a PowerPoint file, is being executed. Once the speaker's operation to the presentation file appears (e.g. skip) in the meantime, the VDP is finished and an operational data is recorded to convert into an operation data packet (ODP), which is arranged after the VDP, while the recording of voice continues and convert into another VDP after the ODP. The VDPs and ODPs are interlacedly and sequentially combined into a presentation record file, which can be synchronously executed with the presentation file for reproducing slides, voice and operations occurring in the then live presentation.

### FIELD OF THE INVENTION

The invention relates to presentations aided by computer, more particularly to recording and reproducing of such a presentation.

### BACKGROUND OF THE INVENTION

Computer presentation programs such as Microsoft PowerPoint have almost completely replaced traditional film-typed slides with overhead projectors. Such presentation systems aided by computer directly generate slide images by means of computers (usually laptop computers). Then the slide images are projected onto a large screen by a projector connected with the computer executing the presentation program.

During a presentation, besides the contents of the computer presentation file (i.e. the virtual slides), a speaker additionally provides much oral information as well. However, there must be some people who can not attend a live presentation due to time and spatial limitations. Even if they obtain a presentation file or its printed copy, lacking the speaker's vocal information always can not make them completely understand the contents of the presentation because of the presentation slides must be brief and outlined. Thus many kinds of presentation recording systems appear in the market. Usually, those systems use a camcorder or camera to shoot field images, use a microphone to record the speaker's voice and ultimately combine the images and voice into a record file. However, such a record file of presentation will require a huge quantity of storage space to store data. It is very disadvantageous to store and convey the record data. Moreover, resolution of the image will also affect definition of the slides for viewers of the record data. For generally commercial or educational presentations, a speaker's appearance or disappearance in the record data of the presentation will not affect a viewer's understanding of a presentation. Therefore, if images of a presentation can be abandoned, then a data quantity of the record file can be effectively reduced.

### SUMMARY OF THE INVENTION

A primary object of the present invention is to provide a method for recording a presentation, which can use a reduced data quantity to record a speaker's voice and his or her operations to the presentation file. Therefore, a record file of presentation can be more advantageous to store and convey.

An another object of the present invention is to provide a method for recording a presentation, which can automatically synchronously reproduce a speaker's voice and his/her operations to the presentation file while the record data of presentation is executing.

To achieve the abovementioned object, the method records the speaker's voice to convert into a voice data packet (VDP) when a presentation file, such as a PowerPoint file, is being executed. Once the speaker's operation to the presentation file appears (e.g. skip) in the meantime, the VDP is finished and an operational data is recorded to convert into an operation data packet (ODP), which is arranged after the VDP, while the recording of voice continues and convert into another VDP after the ODP. The VDPs and ODPs are interlacedly and sequentially combined into a presentation record file, which can be synchronously executed with the presentation file for reproducing slides, voice and operations occurring in the then live presentation.

### BRIEF DESCRIPTION OF THE DRAWINGS

FIG. 1 is a flowchart of the method for recording a presentation of a preferred embodiment of the present invention;

FIG. 2 is a timing diagram of a typical presentation recording of the present invention;

FIG. 3 shows a composition of a presentation record file made by the method for recording a presentation; and

FIG. 4 is a flowchart of executing the presentation record file according to the present invention.

### DETAILED DESCRIPTION OF THE INVENTION

The present invention is to synchronously record a speaker's voice and operations to a presentation file while the presentation file is executing, where the presentation file is a slide file made by a computer software, e.g. a ppt file made by Microsoft PowerPoint, while voice is recorded in a computer by means of a microphone connecting with the computer.

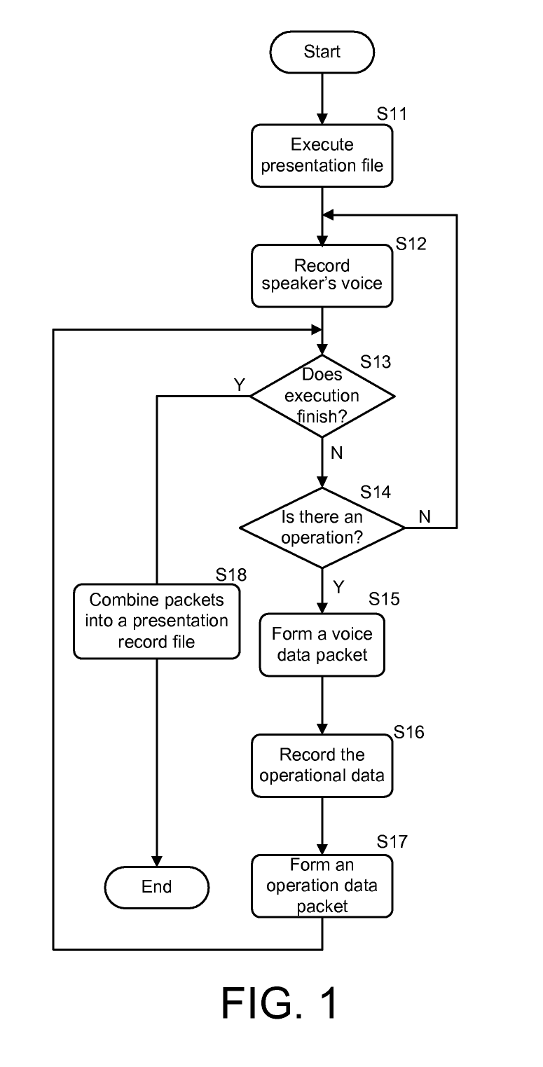

FIG. 1 is a flowchart of the method for recording a presentation according to the present invention. When a presentation file starts being executed in step S11, a speaker's voice is synchronously recorded in step S12. The recording of voice will last to the finish of the presentation file being executed in step S13. In process of the presentation, once an operation to the presentation file by the speaker appears in step 14, such as skip or scroll a slide page, the method instantly processes the vocal data before a time point of the operation to form a voice data packet (“VDP”) in step S15. Meanwhile the recording of voice still continues without interruption. On the other hand, the method instantly records the operational data in step 16, and then forms an operation data packet (“ODP”) in step S17. A plurality of the VDPs and ODPs may be formed during a single presentation. Both the VDPs and the ODPs are ultimately combined into a presentation record file in series with interlacing in step S18.

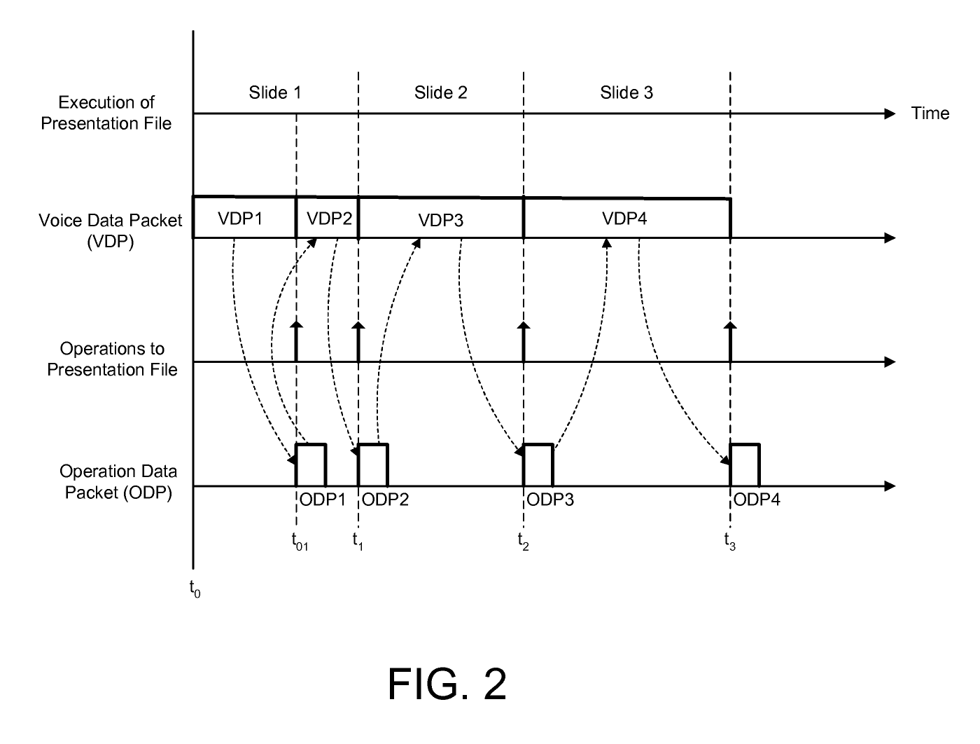

FIG. 2 is a timing diagram of a typical presentation recording of the present invention. Suppose that there are three slides in the presentation file. The presentation file starts being executed at a time point t₀, in the meantime the image of slide 1 is displayed. The presentation file is skipped to slide 2 at time point t₁, then skipped to slide 3 at time point t₂ and ultimately finished at time point t₃. The speaker performs an operation except skip, such as scroll, at time point t₀₁ during slide 1. In other words, four operations in total occur at time points t₀₁ [symbol] t₁ [symbol] t₂ and t₃ during from to t₃, respectively. Therefore, four ODPs (ODP1˜ODP4) are formed at said four time points, respectively. The speaker's voice is recorded from t₀ to t₃, but the whole vocal data is divided into four VDPs (VDP1˜VDP4) by three time points t₀₁ [symbol] t₁ and t₂, respectively. The VDPs and ODPs are interlacedly combined in proper order into a presentation record file, that is the first VDP (VDP1) is arranged at the first, the first ODP (ODP1) is after the VDP1, the second VDP (VDP2) is after ODP1. The presentation record file is finally obtained in this manner, just like the order which is linked by the arrows with dotted line in FIG. 2.

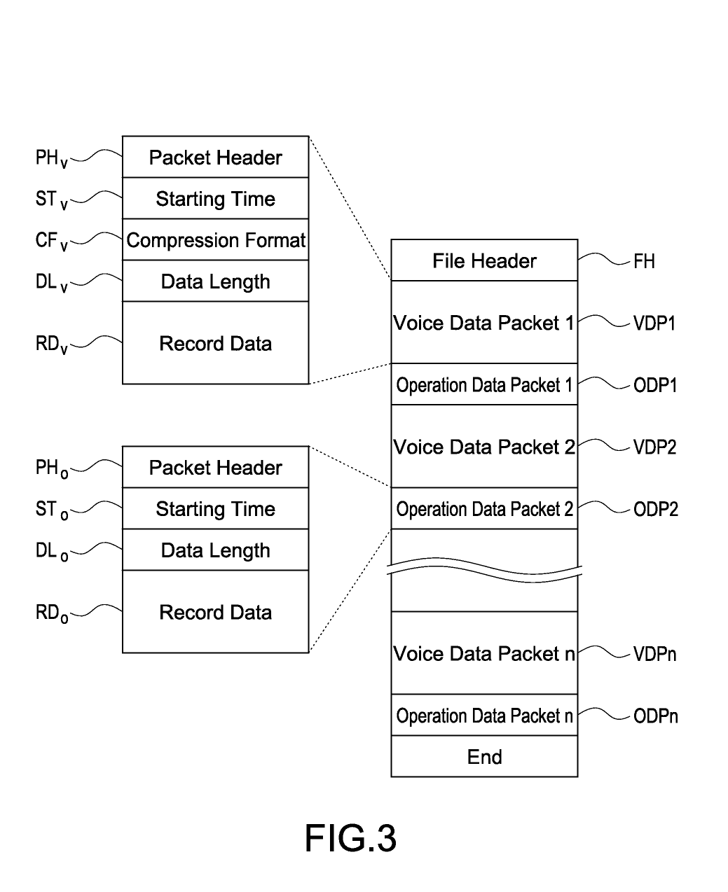

FIG. 3 shows a composition of a presentation record file made by the method for recording a presentation according to the present invention. The start of the presentation record file is a file header (“FH”), which describes the presentation file corresponding to the instant presentation record file so that both the presentation record file and the presentation file can be correctly matched. The voice data packets VDP1˜VDPn and operation data packets ODP1˜ODPn are arranged sequentially and interlacedly after the file header FH as the abovementioned manner. In a preferred embodiment, each VDP includes a packet header (“PH_{V}”), starting time (“ST_{V}”), compression format (“CF_{V}”), data length (“DL_{V}”) and record data (“RD_{V}”). The PH_{V} indicates an attribution of the packet for distinguishability of executing the presentation record file, i.e. the instant packet is a VDP or ODP. The ST_{V} records a starting time of the vocal data (i.e. RD_{V}) in the VDP. The CF_{V} indicates a compression format adopted by the vocal data in the VDP, such as MP3 (MPEG-1 Audio Layer 3) or WMA (Windows Media Audio). The DL_{V} indicates an elapsed time of the vocal data in the VDP. An ending time can be obtained by calculating the DL_{V} and ST_{V}. The RD_{V} is the recorded vocal data.

Similarly, each ODP preferredly includes a packet header (“PH_{O}”), starting time (“ST_{O}”), data length (“DL_{O}”) and record data (“RD_{O}”). Their respective functions are identical with those in VDP. The only difference is that the ODP does not require the compression format. Because operational data is just a single instruction with a small data quantity, it need not be compressed.

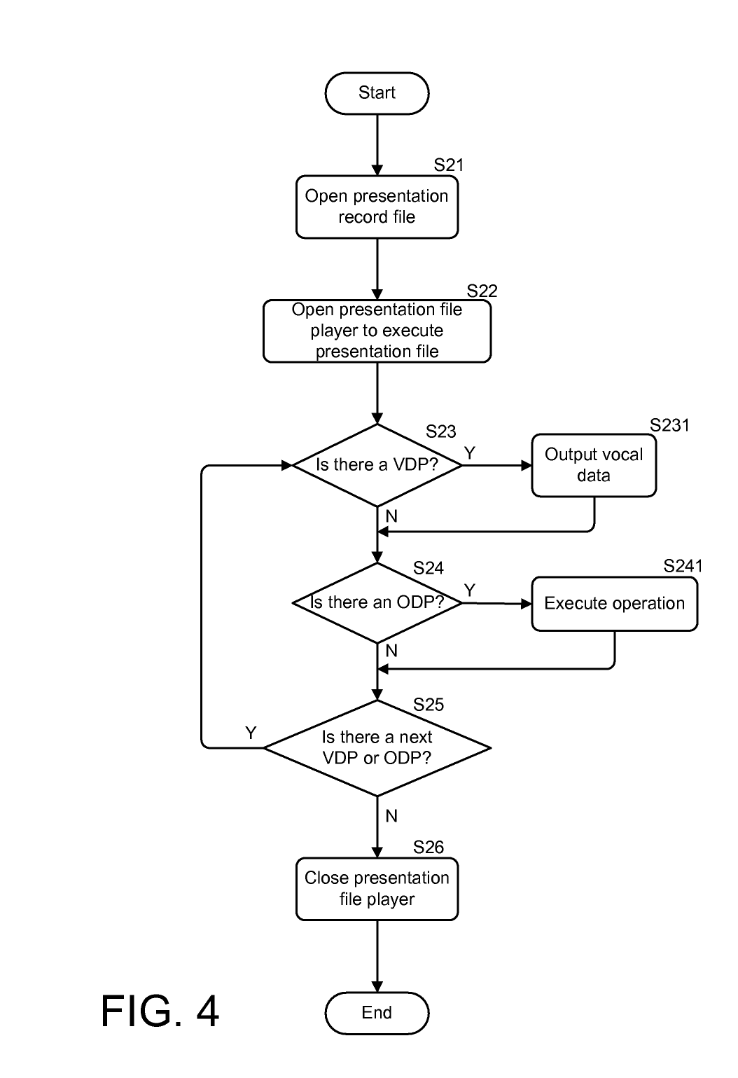

The presentation record file carrying voice and operations, which is recorded in abovementioned method, can guaranty the synchronicity with the presentation file when the two files are simultaneously executed. FIG. 4 shows the executing process of the presentation record file. First, the presentation record file is opened in step S21. The FH is first read out in the opening procedure for starting a presentation file player to execute the presentation file corresponding to the presentation record file in step S22. Then the VDPs and ODPs included in the presentation record file are read out. According to the PH_{V} and PH_{O} of the packets (VDPs and ODPs), that the respective packets are VDPs or ODPs can be determined in step S22. After that, the method proceeds to decode the packet if the packet is a VDP in step S23. And then the vocal data of the decoded VDP is output for sounding in step S231. The method proceeds to decode the packet if the packet is an ODP in step S24. And then the operational data is output for generating a corresponding operation to the execution of the presentation file in step S241. Voice and operations included in the VDPs and ODPs are output and executed, respectively and sequentially in step S25Y. The method closes the presentation file player to finish execution of the presentation file when the last ODP is finish execution of the presentation file in steps S25N and S26. The execution of the presentation file, the speaker's voice and his/her operations to the presentation file can guaranty to be synchronously reproduced as the originally live presentation by means of computer multitasking and time data stored in VDPs and ODPs.

A preferred embodiment of the method are described in its most basic form but steps can be added to or deleted from any of the method and information can be added or subtracted from any of the described packets without departing from the basic scope of the claimed subject matter. It will be apparent to those skilled in the art that many further modifications and adaptations can be made. The particular embodiment is not provided to limit the invention but to illustrate it. The scope of the claimed subject matter is not to be determined by the specific example provided above but only by the claims below.

What is claimed is:

1. A method for recording a presentation, comprising the steps of:
a) executing a presentation file;
b) recording a speaker's voice to form a vocal data;
c) forming a voice data packet (VDP) from the vocal data when an operation to the presentation file appears, while the step b) continues without interruption;
d) recording the operation to form an operational data, while the step b) continues without interruption;
e) after the step d), forming an operation data packet (ODP) from the operational data, while the step b) continues without interrupt; and
f) stopping the step b) and combining the VDP and ODP into a presentation record file when the presentation file finishes.

2. The method of claim 1, wherein the presentation record file is interlacedly and sequentially combined by the VDP and ODP.

3. The method of claim 2, wherein a start of the presentation record file has a file header for indicating the corresponding presentation file.

4. The method of claim 1, wherein the VDP further comprises:
a packet header indicating an attribution thereof;
a starting time recording a starting time of the vocal data in the VDP;
a compression format indicating a compression format adopted by the vocal data in the VDP;
a data length indicating an elapsed time of the vocal data in the VDP; and
a record data being the recorded vocal data.

5. The method of claim 1, wherein the ODP further comprises:
a packet header indicating an attribution thereof;
a starting time recording a starting time of the operational data in the ODP;
a data length indicating an elapsed time of the operational data in the ODP; and
a record data being the recorded operational data.

6. The method of claim 1, wherein the presentation record file further comprises a file header indicating the corresponding presentation file.

7. The method of claim 6, further comprising a process for executing the presentation record file comprising the steps of:
g) opening the presentation record file;
h) starting a presentation player to execute the presentation file corresponding to the opened presentation record file;
i) reading out the packets included in the presentation record file;
j) determining that the read packet is a VDP or an ODP;
k) decoding the packet and outputting the vocal data for sounding if the packet is a VDP;
l) decoding the packet and output the operational data for generating a corresponding operation to the execution of the presentation file if the packet is an ODP; and
m) closing the presentation file player to finish execution of the presentation file when the last ODP is finish execution of the presentation file.

8. The method of claim 7, wherein the step h) is performed according to the file header.
